(19) United States
(12) Patent Application Publication
(10) Pub. No.: US 2017/0124522 A1
(43) Pub. Date: May 4, 2017

(54) METHOD AND APPARATUS FOR IMPLEMENTING AN AUTO WAIT LIST PROCESS IN SCHEDULING OR CALENDARING APPOINTMENTS

(71) Applicant: FLOWARD MOTION, Newport Coast, CA (US)

(72) Inventors: Jimmy Lee, Newport Coast, CA (US); Dennis Cheung, Shatin (HK)

(21) Appl. No.: 15/049,898

(22) Filed: Feb. 22, 2016

Related U.S. Application Data
(63) Continuation of application No. 14/926,925, filed on Oct. 29, 2015.

(51) Int. Cl. G06Q 10/10

(52) U.S. Cl. CPC G06Q 10/1095

(57) ABSTRACT

A method and apparatus are disclosed for a method and apparatus for implementing an auto wait list process in scheduling or calendaring appointments. In one embodiment, the method includes selecting an appointment slot, wherein the appointment slot includes a date and a time and the appointment slot is unavailable for scheduling purposes. The method further includes enabling a user to submit the appointment slot to a wait list. In addition, the method includes saving the appointment slot as a wait list entry in the wait list at the user's submission. The method also includes notifying the user when the appointment slot becomes open due to rescheduling or cancellation, and asking the user whether the user wishes to accept the appointment slot. Furthermore, the method includes assigning the appointment slot to the user, and notifying the user of the assignment.

### CROSS-REFERENCE TO RELATED APPLICATIONS

This application is a continuation of U.S. patent application Ser. No. 14/926,925, filed on Oct. 29, 2015, the entire disclosure of which are incorporated herein by reference.

### FIELD

This disclosure generally relates to the automated scheduling or calendaring, and more particularly, to a method and apparatus for implementing an auto wait list process in scheduling or calendaring appointments.

### BACKGROUND

Currently, scheduling appointments in an electronic calendar typically involves a user selecting one or more convenient and open appointment slots (including date(s) and time(s)) and saving such appointment slots. Some electronic calendaring applications may notify of upcoming appointments. However, it appears that there is currently no electronic calendaring system or application that provides an auto wait list process in which the user could select and save one or more preferred appointment slots in a wait list and the user could be informed when the preferred appointment slots become open and available. Such automatic wait list process may be needed and useful.

### SUMMARY

A method and apparatus are disclosed for a method and apparatus for implementing an auto wait list process in scheduling or calendaring appointments. In one embodiment, the method includes selecting an appointment slot, wherein the appointment slot includes a date and a time and the appointment slot is unavailable for scheduling purposes. The method further includes enabling a user to submit the appointment slot to a wait list. In addition, the method includes saving the appointment slot as a wait list entry in the wait list at the user's submission. The method also includes notifying the user when the appointment slot becomes open due to rescheduling or cancellation, and asking the user whether the user wishes to accept the appointment slot. Furthermore, the method includes assigning the appointment slot to the user, and notifying the user of the assignment.

### BRIEF DESCRIPTION OF THE DRAWINGS

FIG. 1 shows a diagram of a network according to one exemplary embodiment.

FIG. 2 is a flow diagram according to one exemplary embodiment.

FIG. 3 is a user login screen or page according to one exemplary embodiment.

FIGS. 4, 5, and 6 are iterations of an appointment screen or page according to one exemplary embodiment.

FIG. 7 is a notification email according to one exemplary embodiment.

FIGS. 8A and 8B illustrate iterations of a new waitlist entry screen or page according to one exemplary embodiment.

FIG. 9 shows a wait list screen or page according to one exemplary embodiment.

FIG. 10 is a flow diagram according to one exemplary embodiment.

FIG. 11 is a text message notification according to one exemplary embodiment.

FIGS. 12A and 12B are text message reminders according to one exemplary embodiment.

FIG. 12C is a text message notification according to one exemplary embodiment.

FIG. 13 is a functional block diagram of a communication device according to one exemplary embodiment

FIG. 14 shows a functional block diagram of the program code of FIG. 3 according to one exemplary embodiment.

### DETAILED DESCRIPTION

In general, the present invention involves an electronic calendar system or application that implements an auto wait list process in which the user could select and save one or more preferred appointment slots in a wait list when such slots are not available. When an appointment slot becomes open and available due to cancellation or rescheduling, the open appointment slot would then be checked against the preferred appointment slots saved in the wait list. If the open appointment slot matches a preferred appointment slot in the wait list, the user would be notified and given an opportunity to book the open appointment slot. Additional details of the present invention are described and discussed below.

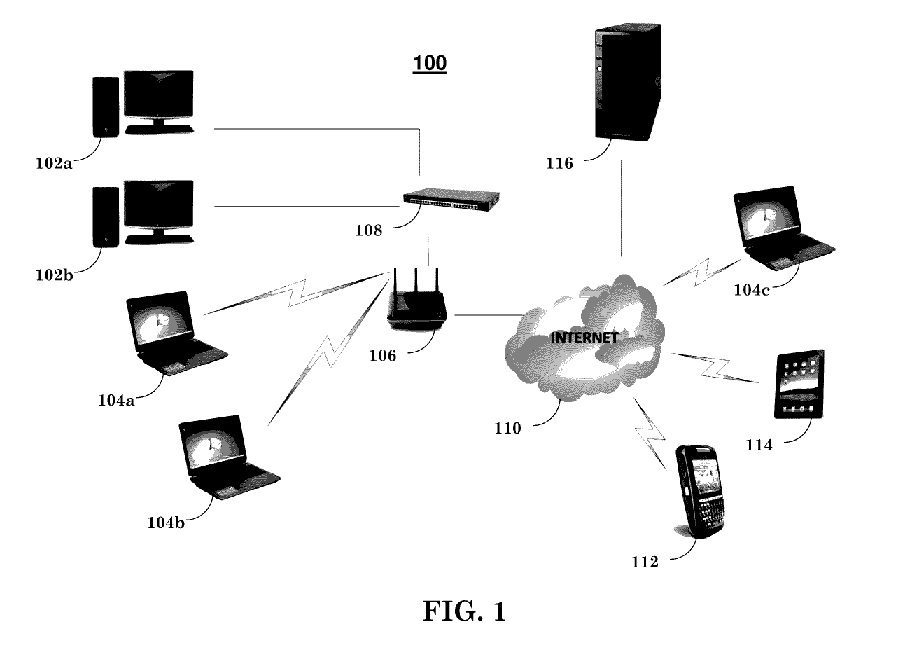

FIG. 1 illustrates a network 100 connecting different types of devices according to one embodiment of the invention. In one embodiment, the network 100 is an environment in which the auto wait list process operates. As shown in FIG. 1, desktops 102a and 102b could be connected to the Internet 110 through a hub or switch 108 and a modem 106 in one embodiment. Laptops 104a and 106 could also be connected to the Internet 110 through the modem 106 via wireless connections in one embodiment. In addition, laptop 104c, tablet 114, and mobile phone 112 could be connected to the Internet 110 via wireless connections. Server 116 could be connected to the Internet 110. In one embodiment, the server 116 could be configured to include software sufficient to implement and support the auto wait list process.

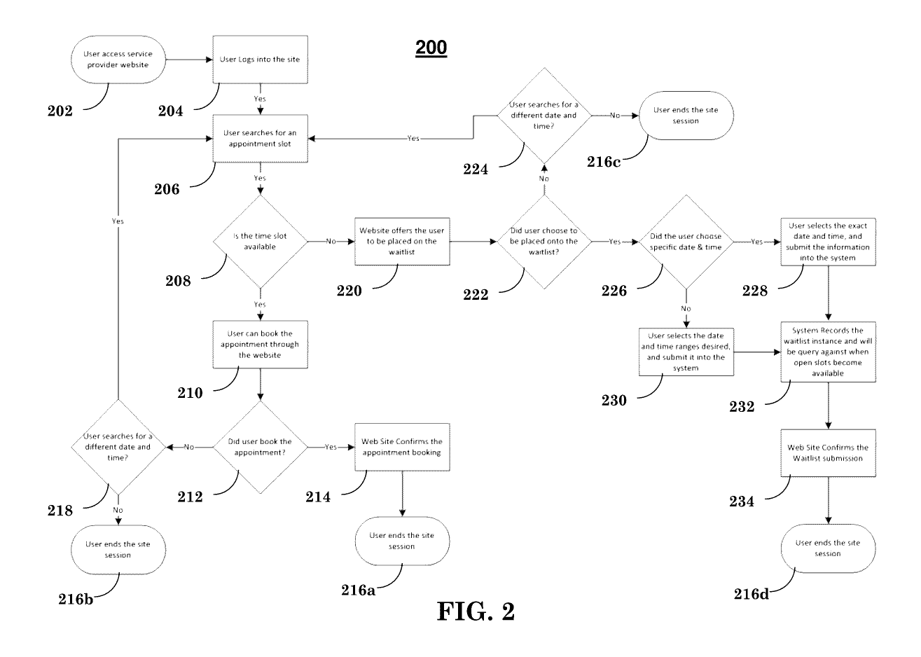

FIG. 2 is a flow diagram 200 generally describing portions of the auto wait list process according to one exemplary embodiment. The logic illustrated and outlined in the flow diagram 200 of FIG. 2 could be implemented in one or more of the devices of the network 100 shown in FIG. 1. In block 202, the user accesses the service provider website that provides the scheduling or calendaring service with the auto wait list process. In general, the user would access the service provider website through a standard web browser running on a communication device (such as a desktop 102a-102b, a laptop 104a-104c, a server 116, a mobile phone 112, or a tablet 114 shown in FIG. 1). In step 204, the user would log into the service provider website using the user's login information.

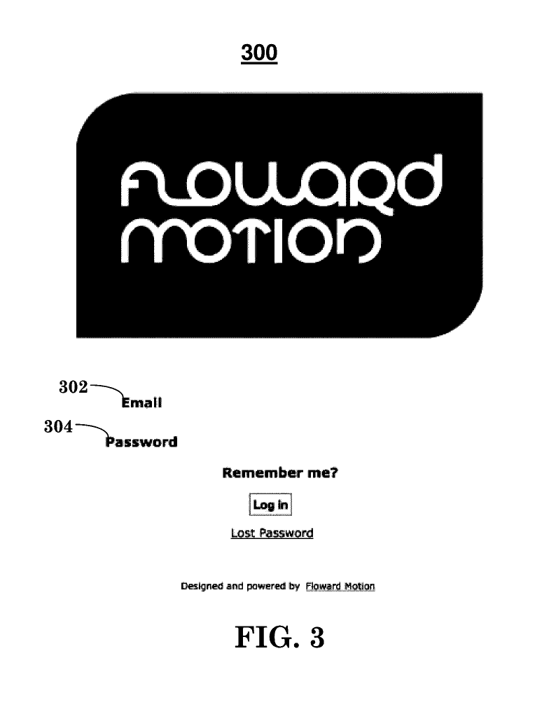

Turning to FIG. 3, this figure illustrates a user login screen or page according to one exemplary embodiment. As shown in FIG. 3, the user would login by entering a valid email address 302 corresponding to a valid user account, and a valid password 304. Once the user login information has been authenticated, the user will be taken to the user's profile page (note shown) which would default to the subpage that displays a screen or page showing upcoming appointment(s).

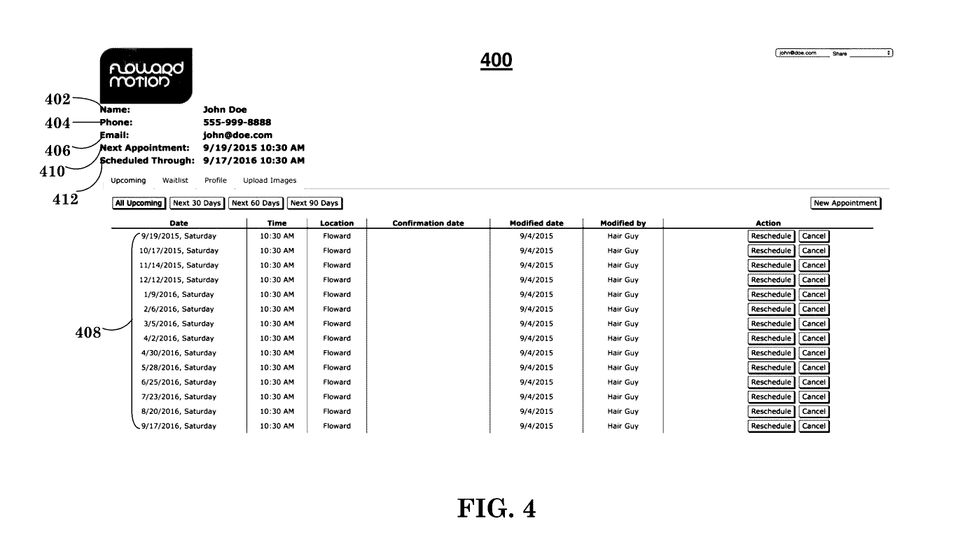

FIG. 4 shows an iteration of a screen or page 400 that displays the entire roster of upcoming appointment(s) for the user according to one exemplary embodiment. In one embodiment, the appointment screen or page 400 could include user information, such as the user name 402, phone 404, and/or email address 406. The appointment screen or page 400 could list the next scheduled appointment 410. The appointment screen or page 400 could provide the list 408 of one or more appointments which had already been scheduled. The “Scheduled Through” field 412 represents the appointment furthest out into the future (or in other words, the maximum date in the roster of appointments).

The user could schedule appointments at the appointment screen or page 400. The process of scheduling appointments is illustrated in FIG. 2. As shown in FIG. 2, the user searches for an appointment slot in block 206. Once the user selects an appointment slot, a check is made to determine whether the selected appointment slot is available in block 208. If the selected appointment slot is available, the user could book the appointment through the website in block 210. In block 212, a check is made to determine whether the user had booked the appointment. If the user had booked the appointment, the web site confirms the booking in block 214. The user could then end the session in block 216a.

However, if the user did not book the appointment in block 212, the user has an option to search for a different appointment slot in block 218. If the user decides not to search a different appointment slot, the user could then end the session in block 216b. But if the user decides to search for a different appointment slot in block 218, the user would be taken back to block 206 where the user could select a different appointment slot.

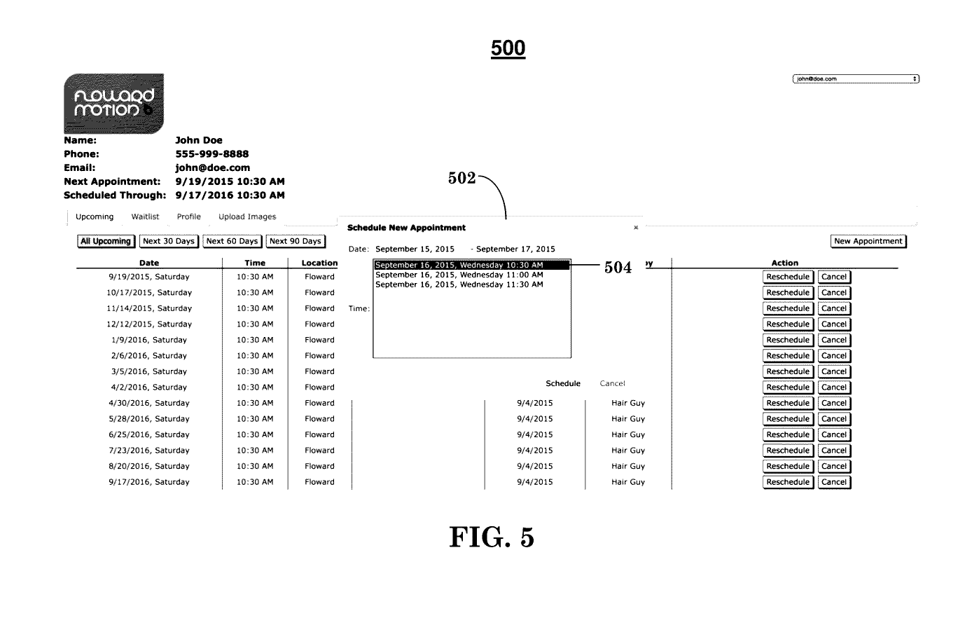

FIG. 5 illustrates an iteration of the appointment screen or page 500 in according to one exemplary embodiment. As seen in FIG. 5, the appointment screen or page 500 includes a “Schedule New Appointment” pop-up window 502 that presents possible appointment slots (including dates and times) that the user could select. The user's selected appointment slot 504 would be highlighted as shown in FIG. 5.

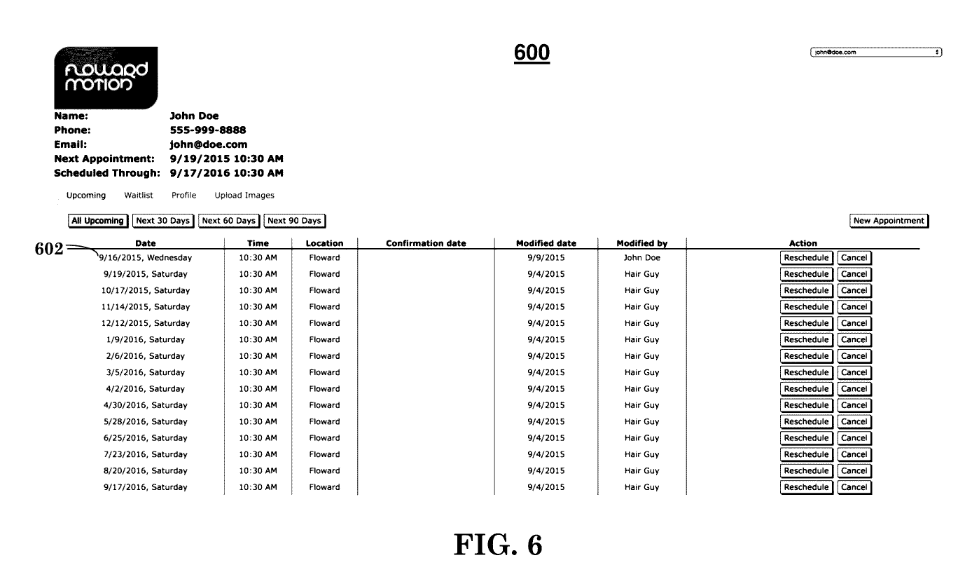

FIG. 6 shows an iteration of the appointment screen or page 600 in according to one exemplary embodiment. Assuming that the user selected and booked the appointment slot of 10:30 AM on Wednesday Sep. 16, 2015, the appointment screen or page 600 would reflect such selection and booking 602.

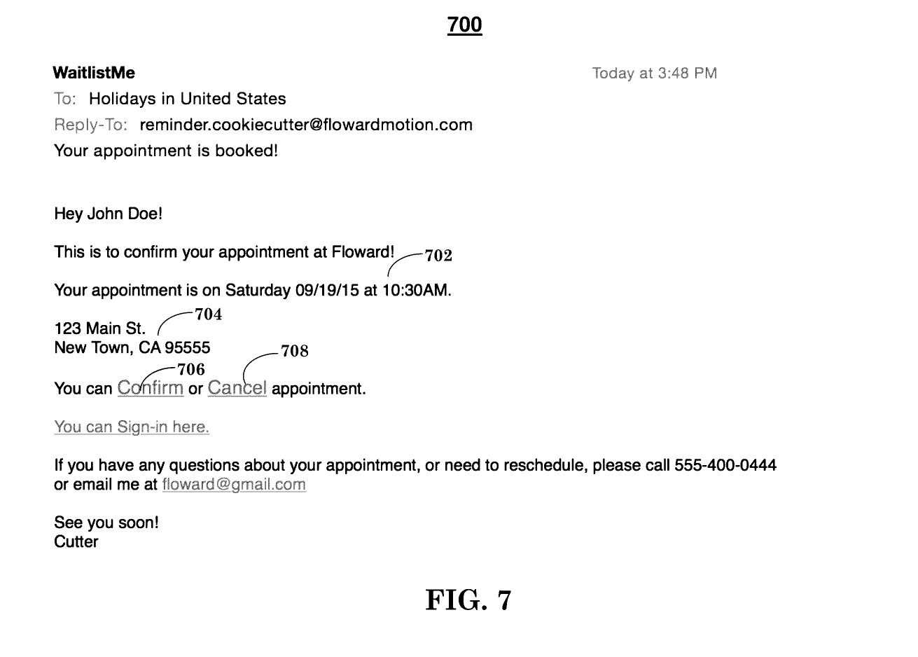

FIG. 7 shows a notification email 700 according to one exemplary embodiment. In one embodiment, the notification email 700 is sent to an email address specified (or configured) by the user after the user selected and booked an appointment slot (shown and discussed block 214 of FIG. 2). As shown in FIG. 7, the email 700 could include the date and time 702 and the address of the appointment 704. Furthermore, the confirmation email could include links to confirm 706 or cancel 708 the appointment.

Turning back to FIG. 2, if it is determined in block 208 that the appointment slot that the user selected is not available, the user is offered an opportunity to place the selected appointment slot onto a wait list in block 220. In block 222, a check is made to determine whether the user had chosen to put the selected appointment slot onto the wait list.

If the user did not choose to put the selected appointment slot onto the wait list in block 222, a check is made in block 224 to determine whether the user had searched for a different appointment slot. If user had searched for a different appoint slot in block 224, the user would be taken back to block 206 where the user could select a different appointment slot. However, if the user had not searched for a different appoint slot in block 224, the user could end the session in block 216c.

If the user chose to put the selected appointment slot onto the wait list in block 222, a check is made in block 226 to determine whether the user had chosen a specific date and/or time. If the user selected a specific date and/or time, the specific date and/or time would be submitted in block 228. If the user selected a range of dates and/or times, such range would be submitted in block 230. In block 232, the selected specific date and/or time or the selected range of dates and/or times is recorded or saved and will be queried against when one or more open appointment slots becomes available. In block 234, the wait list submission is confirmed. The user could then end the session in block 216d.

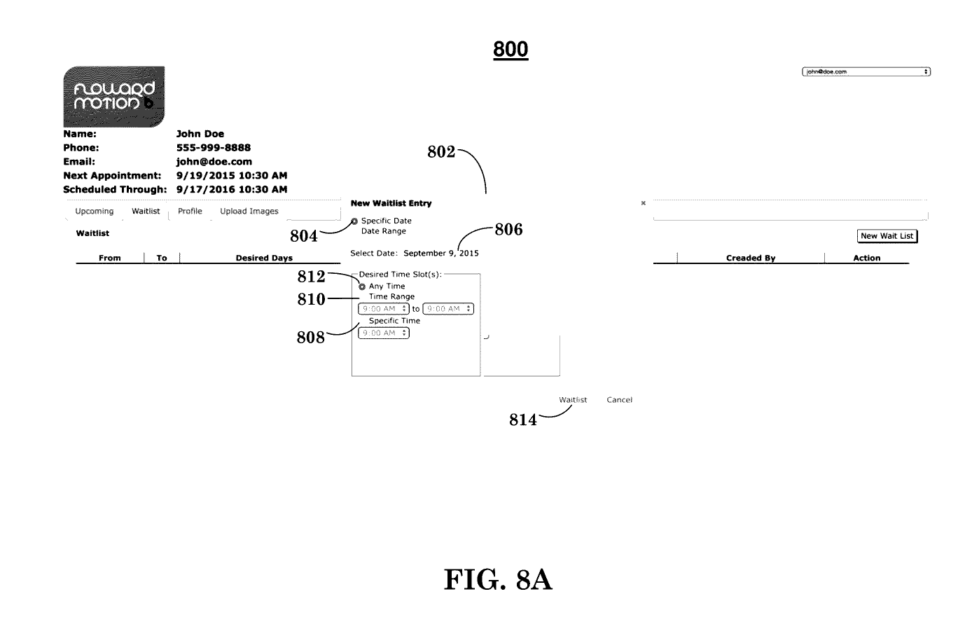

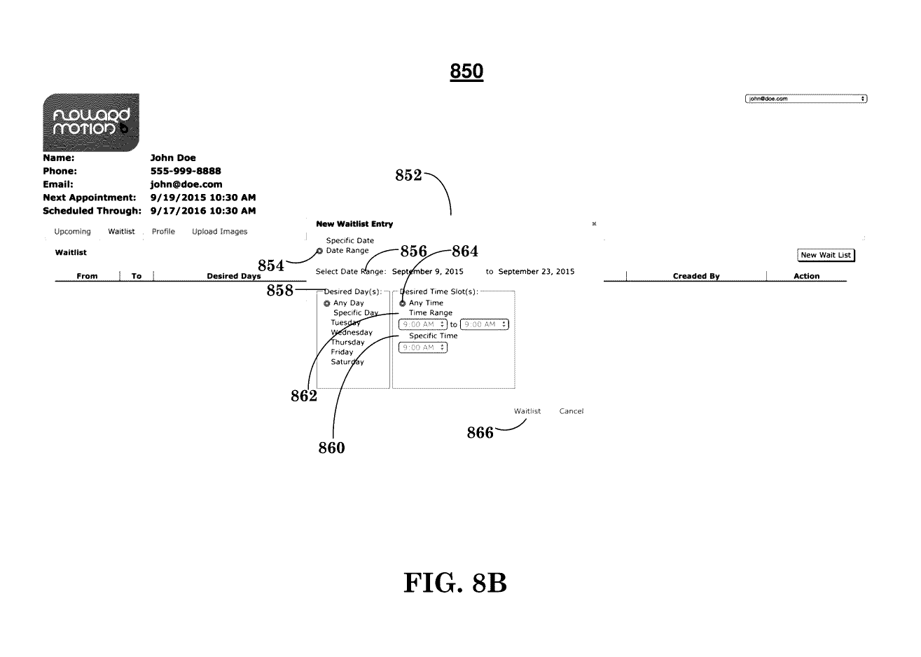

FIG. 8A illustrates an iteration of a wait list screen or page 800 according to one exemplary embodiment. As shown in FIG. 8A, the wait list screen or page 800 includes an exemplary “New Waitlist Entry” pop-up window 802 in which the specific date option 804 has been selected. For illustration purposes, the exemplary “New Waitlist Entry” pop-up window 802 shows that Sep. 9, 2015 has been selected 806. In addition to the selecting a specific date, the user could select a specific time 808, a time range 810, or any time of the day 812. Once the user selects the appropriate date and time(s), the user could select the “Waitlist” button (or option) 814 to submit the selection.

FIG. 8B illustrates an iteration of a wait list screen or page 850 according to one exemplary embodiment. As shown in FIG. 8B, the wait list screen or page 850 includes an exemplary “New Waitlist Entry” pop-up window 852 in which a date range option 854 has been selected. For illustration purposes, the exemplary “New Waitlist Entry” pop-up window 852 shows that a date range of Sep. 9, 2015 to Sep. 23, 2015 has been selected 856. In addition to the selecting a date range, the user could select one or more desired days 858 within the date range. The user could also select a specific time 860, a time range 862, or any time of the day 864. Once the user selects the appropriate date(s) and time(s), the user could select the “Waitlist” button (or option) 866 to submit the selection.

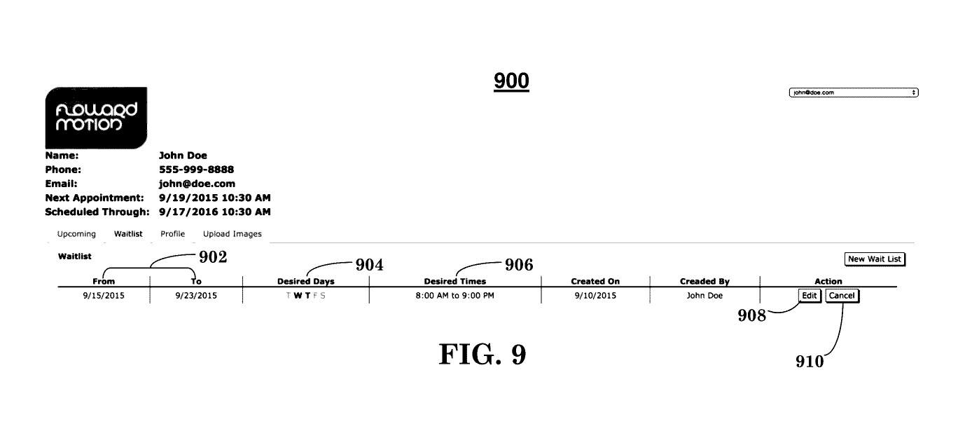

FIG. 9 illustrates an iteration of a wait list screen or page 900 according to one exemplary embodiment. For illustration purposes, the wait list screen or page 900 in FIG. 9 shows the result of a submission of a wait list entry in which the user selected a date range (similar to the illustration shown in FIG. 8). As shown in FIG. 9, the user selected the date range 902 of Sep. 15, 2015 to Sep. 23, 2015. Within the date range, the user selected the desired days of Wednesday and Thursday 904, and the desire time range 906 of 8:00 AM to 9:00 PM. As further shown in FIG. 9, the user could select the Edit button (or option) 908 to edit the submitted wait list entry, or the Cancel button (or option) 910 to cancel the submitted wait list entry.

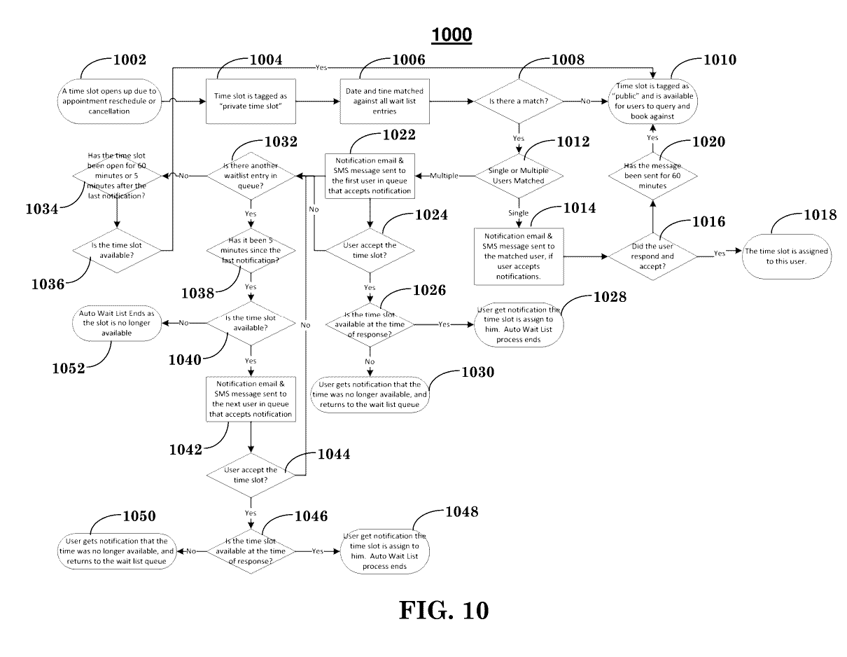

FIG. 10 is a flow diagram 1000 generally illustrating portions of the auto wait list process after the submission of the wait list entry according to one exemplary embodiment. The logic illustrated and outlined in the flow diagram 1000 of FIG. 10 could be implemented in one or more of the devices of the network 100 shown in FIG. 1. In block 1002, an appointment slot (or time slot) opens up due to an appointment reschedule or cancellation. In one embodiment, the opened appointment slot (or time slot) is tagged as “private time slot” as shown in block 1004. In general, the tag “private time slot” denotes that the appointment slot is open, and that the appointment slot will be matched against the wait list entries that have been submitted and recorded as shown in block 232 of FIG. 2 and discussed above. While the open appointment slot is tagged as “private time slot”, no user could query and book the appointment slot even though it is open.

In block 1006, the date and time of the open appointment slot is matched against the wait list entries that have been submitted and recorded as shown in block 232 of FIG. 2 and discussed above. In block 1008, a check is performed to determine whether the open appointment slot matches one or more recorded (or saved) wait list entries. If there is no match, the open appointment slot is tagged as “public” in block 1010. In general, the tag “public” denotes that the appointment slot is open and is available for users to query and book.

If it is determined that there is a match in block 1008, a check is performed in block 1012 to determine whether there has been a match for a wait list entry submitted by a single user or for wait list entries submitted by multiple users. If there is a match for a wait list entry submitted by a single user, notification(s) will be sent to the matched user in block 1014. In one embodiment, the notification could be an email that is sent to an email address specified by the user.

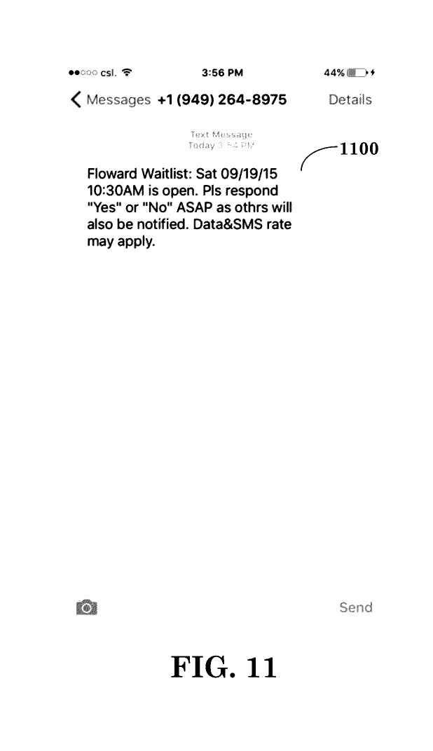

In an alternative embodiment, the notification could be a text message sent to a phone number specified by the user. FIG. 11 illustrates a notification text message 1100 according to one embodiment. In the context of FIG. 11, an appointment slot at 10:30 AM on Saturday Sep. 19, 2015 had opened up. Assuming that the user submitted a wait list entry that matches the open appointment slot, the text message 1100 is sent to the phone specified by the user. The text message 1100 includes information (e.g., date and time) about the appointment slot, and asks the user to accept or decline the appointment slot.

Turning back to FIG. 10, a check is made in block 1016 to determine whether the user responded and accepted the open appointment slot. If the user responds and accepts the open appointment slot, the slot is assigned to the user in block 1018. If the user does not respond or accept the open time slot, the user would be given a predetermined response wait time to do so in block 1020. If the user does not respond and accept the open time slots within the given predetermined response wait time, the open appointment slot is tagged as “public” in block 1010. In the embodiment shown in block 1020, the user is given a predetermined response wait time of time of sixty (60) minutes to respond and accept the open appointment slot. In an alternative embodiment, the predetermined response wait time could be configured and set to any amount of time deemed reasonable to wait for the user to respond.

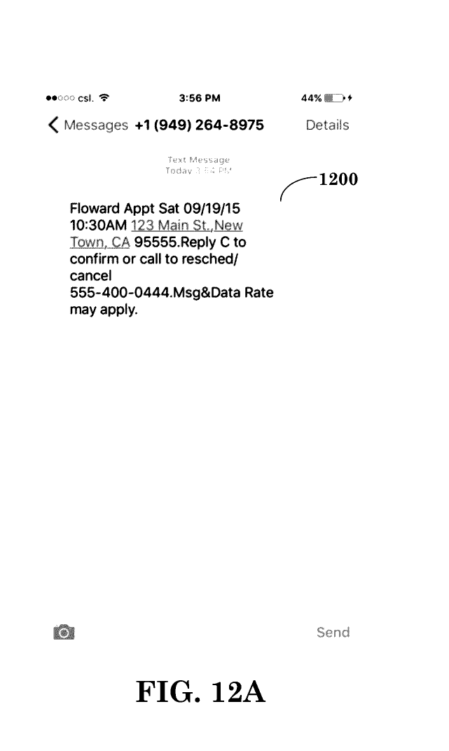

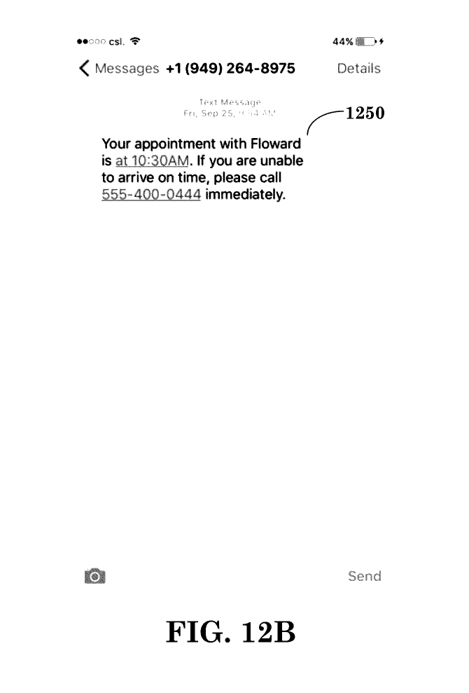

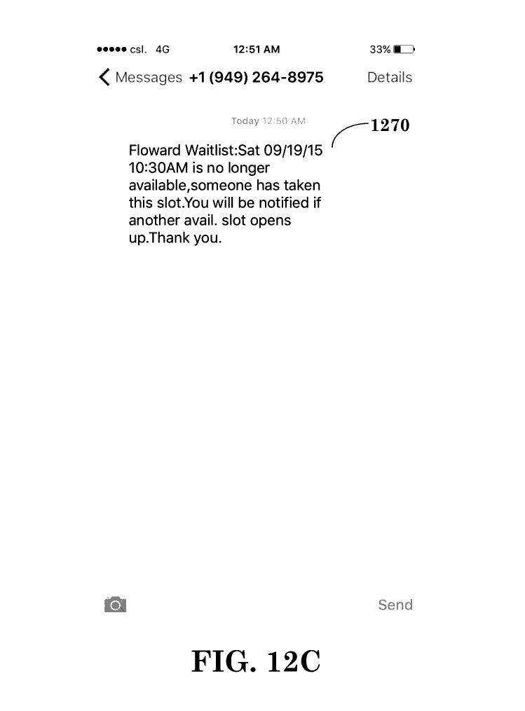

In one embodiment, after the user accepts the open appointment slot and the slot has been assigned to the user in block 1018, a first reminder could be sent to the user one or a few days prior to the appointment. In one embodiment, the first reminder could be an email that is sent to an email address specified by the user. In an alternative embodiment, the first reminder could be a text message sent to a phone specified by the user. FIG. 12A illustrates a first reminder text message 1200 according to one embodiment. As shown in FIG. 12A, the first reminder text message 1200 includes information (e.g., date and time) about the appointment and an address for the appointment. The first reminder text message 1200 also asks the user to confirm or to reschedule/cancel the appointment.

In one embodiment, a second reminder could be sent to the user one or a few hours prior to the appointment. In one embodiment, the second reminder could be an email that is sent to an email address specified by the user. In an alternative embodiment, the second reminder could be a text message sent to a phone specified by the user. FIG. 12B illustrates a second reminder text message 1250 according to one embodiment. As shown in FIG. 12B, the second reminder text message 1250 includes information (e.g., time) about the appointment. The second reminder text message 1250 also asks the user to call if the user cannot arrive on time.

Turning back to FIG. 11, if there is a match for multiple wait list entries submitted by multiple users, notification(s) will be sent to the first matched user in queue in block 1022. An example of a text message notification is shown in FIG. 11 and discussed above. The notification could also be an email sent to an address specified by the user. In block 1024, a check is made to determine whether the user accepted the open appointment slot. If the user accepts the open time slot, a check is made in block 1026 to determine whether the open appointment slot is still available at the time that the user responded. If the open appointment slot is still available, the open time slot is assigned to the user, and notification(s) will be sent to the user in block 1028. Examples of text message notifications are shown in FIGS. 12A and 12B and discussed above. The notifications could also be emails sent to an address specified by the user.

If it is determined that the open time slot is no longer available, a notification will be sent to the user, and the user and the submitted wait list entries will be returned to the wait list queue in block 1030 to be matched with other appointment slots that may open up in the future due to rescheduling or cancellation (as shown in block 1002 and discussed above). FIG. 12C illustrates a notification text message 1270 informing the user that the time slot is no longer available according to one embodiment. As shown in FIG. 12C, the notification text message 1270 could also inform the user that the user will be notified if and when another available appointment opens up.

In general, the open time slot would be offered to a first matched user. Then the slot would be offered to a second matched user after a predetermined offer delay. In other words, the open time slot could be offered to multiple matched users after a predetermined offer delay between each offer. The second matched user could accept the open time slot before the first matched user. In such case, the open time slot would no longer be available when the first matched user accepts the slot. In the embodiment shown in FIG. 10, the predetermined offer delay could be set to five (5) minutes. In an alternative embodiment, the predetermined offer delay could be set to shorter or longer than minutes or to any amount of time deemed reasonable.

After notification is sent to the first matched user in block 1022, a check is performed in block 1032 to determine whether there is another matched wait list entry and user in the queue. Also, if the first matched user does not accept the open appointment slot in block 1024, the check in block 1032 is performed.

If it is determined in block 1032 that there is no other matched waitlist entry and user in the queue, a check is performed in block 1034 to determine whether the appointment slot has been opened for the predetermined response wait time (e.g., 60 minutes as shown in block 1034) or a predetermined offer delay (e.g., 5 minutes as shown in block 1034) has expired. If yes, a check is performed in block 1036 to determine whether the open time slot is still available. If the open time slot is still available, the slot will be tagged as “public” in block 1010.

If it is determined in block 1032 that there is another matched waitlist entry and user (referred to as the next matched user below) in the queue, a check is performed in block 1038 to determine whether the predetermined offer delay has expired. If the predetermined offer delay has expired, a check is made in block 1040 to determine whether the open appointment slot is still available. If the open appointment slot is still available, the slot will be offered to the next matched user, and notification(s) will be sent to the next matched user in block 1042. An example of a text message notification is shown in FIG. 11 and discussed above. The notification could also be an email sent to an address specified by the user. If it is determined in block 1040 that the open appointment slot is not available, the auto wait list process would end in block 1052.

In block 1044, a check is performed to determine whether the user accepts the open time slot. If the user does not accept the open time slot, the process goes back to block 1032 to determine whether there is yet another match. However, if the user accepts the open time slot, a check is made in block 1046 to determine whether the open time slot is still available. If the user accepts the open time slot, the open time slot is assigned to the user, and notification(s) will be sent to the user in block 1048. Examples of text message notifications are shown in FIGS. 12A and 12B and discussed above. The notifications could also be emails sent to an address specified by the user.

If it is determined that the open time slot is no longer available, a notification will be sent to the user, and the user and the submitted wait list entries will be returned to the wait list queue in block 1050 to be matched with other appointment slots that may open up in the future due to rescheduling or cancellation (as shown in block 1002 and discussed above). FIG. 12C illustrates a notification text message 1270 informing the user that the time slot is no longer available according to one embodiment.

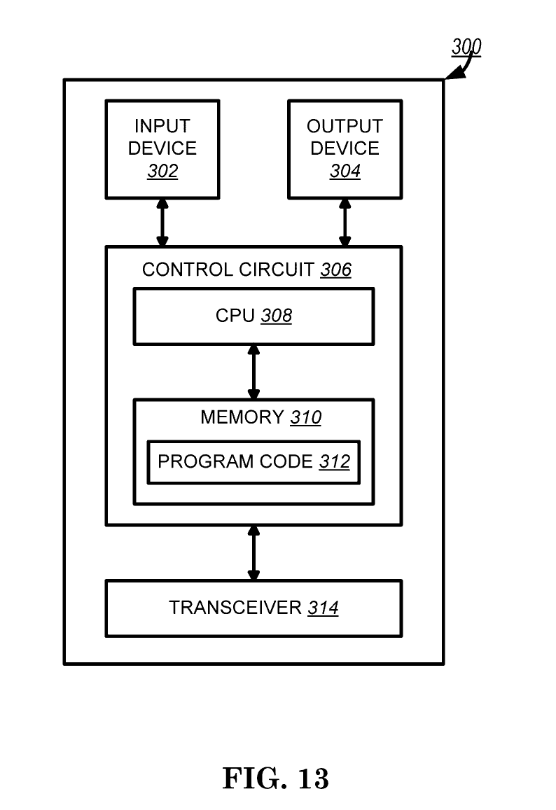

Turning to FIG. 13, this figure shows a simplified functional block diagram of a communication device according to one embodiment of the invention. As shown in FIG. 13, the communication device 1300 can be utilized for realizing the server 116, desktops 102a and 102b, laptops 104a-104c, mobile phone 112, and tablet 114 in FIG. 1. The communication device 1300 may include an input device 1302, an output device 1304, a control circuit 1306, a central processing unit (CPU) 1308, a memory 1310, a program code 1312, and a transceiver 1314. The control circuit 1306 executes the program code 1312 in the memory 1310 through the CPU 1308, thereby controlling an operation of the communications device 1300. The communications device 1300 can receive signals input by a user through the input device 1302, such as a keyboard or keypad, and can output images and sounds through the output device 1304, such as a monitor or speakers. The transceiver 1314 is used to receive and transmit communication signals, delivering received signals to the control circuit 306, and outputting signals generated by the control circuit 306.

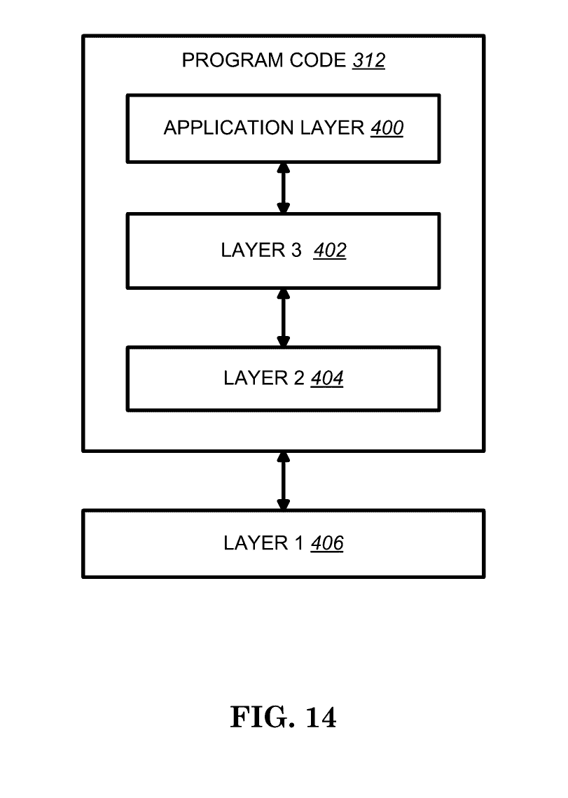

FIG. 14 is a simplified block diagram of the program code 1312 shown in FIG. 3 in accordance with one embodiment of the invention. In this embodiment, the program code 1312 includes an application layer 1400, a Layer 3 portion 1402, and a Layer 2 portion 1404, and is coupled to a Layer 1 portion 1406. The Layer 3 portion 1402 generally performs radio resource control. The Layer 2 portion 1404 generally performs link control. The Layer 1 portion 1406 generally performs physical connections.

Referring back to FIGS. 13 and 14, in one embodiment from the perspective of a base station, the device 1300 includes a program code 1312 stored in memory 1310 to apply beam-forming for transmission and/or reception in the cell and there are at least two beams in the cell. The CPU 1308 could execute program code 1312 (i) to select an appointment slot, wherein the appointment slot includes a date and a time and the appointment slot is unavailable for scheduling purposes, (ii) to enable a user to submit the appointment slot to a wait list, (iii) to save the appointment slot to the wait list at the user's submission, (iv) to notify the user when the appointment slot becomes open due to rescheduling or cancellation, and to ask the user whether the user wishes to accept the appointment slot and (iv) to assign the appointment slot to the user, and to notify the user of the assignment. In addition, the CPU 308 can execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for implementing an auto wait list process in scheduling appointments, comprising:
selecting an appointment slot, wherein the appointment slot includes a date and a time and the appointment slot is unavailable for scheduling purposes;
enabling a user to create and submit a wait list entry to a wait list, wherein the wait list entry includes the date and the time of a desired appointment slot;
saving the wait list entry in the wait list at the user's submission;
notifying the user when a newly open appointment slot becomes available due to rescheduling or cancellation, wherein the newly open appointment slot is tagged as “private time slot” to prevent other users from booking the newly open appointment slot;
allowing the user to accept or refuse, within a predetermined response wait time, the newly open appointment slot if the newly open appointment slot matches the wait list entry, wherein the predetermined response wait time is configurable and is set to any amount of time deemed reasonable to wait for the user to respond;
assigning the newly open appointment slot to the user if the user accepts the newly open appointment slot, and notifying the user of the assignment;
returning the wait list entry to the wait list if the user refuses the newly open appointment slot; and
tagging the newly open appointment slot as “public” if the user refuses the newly open appointment slot to denote that the newly open appointment slot is available for other users to book.

2. The method of claim 1, further comprising:
enabling the user to cancel the wait list entry saved in the wait list.

3. The method of claim 1, further comprising:
enabling the user to edit the wait list entry saved in the wait list.

4. The method of claim 1, further comprising:
sending a first reminder days in advance of an upcoming appointment to remind the user of the upcoming appointment.

5. The method of claim 4, further comprising:
sending a second reminder hours in advance of the upcoming appointment to reminder the user of the upcoming appointment.

6. The method of claim 5, wherein the first reminder and the second reminder could be emails or text messages.

7. The method of claim 1, further comprising:
enabling the user to include a date range and/or desired day(s) in the wait list entry to be saved to the wait list.

8. The method of claim 1, further comprising:
enabling the user to include a time range in the wait list entry to be saved to the wait list.

9. The method of claim 1, further comprising:
notifying a first user when the newly open appointment slot becomes available due to rescheduling or cancellation, and asking the first user whether the first user wishes to accept the newly open appointment slot; and
if the first the first user does not accept the newly open appointment slot, notifying other users and asking the other users whether they wish to accept the newly open appointment slot.

10. The method of claim 1, further comprising:
notify the user if the newly open appointment slot has been taken by another user and is no longer available; and
returning the wait list entry back to the wait list.

11. A communication device for implementing an auto wait list process in scheduling appointments, comprising:
a control circuit;
a processor installed in the control circuit; and
a memory installed in the control circuit and operatively coupled to the processor;
wherein the processor is configured to execute a program code stored in the memory to:
select an appointment slot, wherein the appointment slot includes a date and a time and the appointment slot is unavailable for scheduling purposes;
enable a user to create and submit a wait list entry to a wait list, wherein the wait list entry includes the date and the time of a desired appointment slot;
save the wait list entry in the wait list at the user's submission;
notify the user when a newly open appointment slot becomes available due to rescheduling or cancellation, wherein the newly open appointment slot is tagged as “private time slot” to prevent other users from booking the newly open appointment slot;
allow the user to accept or refuse, within a predetermined response wait time, the newly open appointment slot if the newly open appointment slot matches the wait list entry, wherein the predetermined response wait time is configurable and is set to any amount of time deemed reasonable to wait for the user to respond;
assign the newly open appointment slot to the user if the user accepts the newly open appointment slot, and notifying the user of the assignment;
return the wait list entry to the wait list if the user refuses the newly open appointment slot; and
tag the newly open appointment slot as “public” if the user refuses the newly open appointment slot to denote that the newly open appointment slot is available for other users to book.

12. The communication device of claim 11, wherein the process is further configured to execute the program code stored in the memory to enable the user to cancel the wait list entry saved in the wait list.

13. The communication device of claim 11, wherein the process is further configured to execute the program code stored in the memory to enable the user to edit the wait list entry saved in the wait list.

14. The communication device of claim 11, wherein the process is further configured to execute the program code stored in the memory to send a first reminder days in advance of an upcoming appointment to remind the user of the upcoming appointment.

15. The communication device of claim 14, wherein the process is further configured to execute the program code stored in the memory to send a second reminder hours in advance of the upcoming appointment to reminder the user of the upcoming appointment.

16. The communication device of claim 15, wherein the first reminder and the second reminder could be emails or text messages.

17. The communication device of claim 11, wherein the process is further configured to execute the program code stored in the memory to enable the user to include a date range and/or desired day(s) in the wait list entry to be saved to the wait list.

18. The communication device of claim 11, wherein the process is further configured to execute the program code stored in the memory to enable the user to include a time range in the wait list entry to be saved to the wait list.

19. The communication device of claim 11, wherein the process is further configured to execute the program code stored in the memory to:
notify a first user when the newly open appointment slot becomes available due to rescheduling or cancellation, and ask the first user whether the first user wishes to accept the newly open appointment slot; and
if the first the first user does not accept the appointment slot, notify other users and ask the other users whether they wish to accept the newly open appointment slot.

20. The communication device of claim 11, wherein the process is further configured to execute the program code stored in the memory to:
notify the user if the newly open appointment slot has been taken by another user and is no longer available; and
returning the wait list entry back to the wait list.
